(19) United States
(12) Patent Application Publication
(10) Pub. No.: US 2025/0385899 A1
(43) Pub. Date: Dec. 18, 2025

(54) PUTTING A DIGITAL CERTIFICATE INTO SERVICE

(71) Applicant: VEGA Grieshaber KG, Wolfach (DE)

(72) Inventor: Hendrik Schutter, Rheinau (DE)

(21) Appl. No.: 19/234,924

(22) Filed: Jun. 11, 2025

(30) Foreign Application Priority Data
Jun. 12, 2024 (DE) 10 2024 116 525.1

(51) Int. Cl. H04L 9/40

(52) U.S. Cl. CPC H04L 63/0823; H04L 63/102; H04L 63/162

(57) ABSTRACT

A method for putting a digital certificate of a field device into service on a terminal, which comprises: Sending an inquiry for transmitting the digital certificate to the field device by way of the terminal, receiving the inquiry for transmitting the digital certificate by the field device, in response to receiving the inquiry for transmitting the digital certificate, sending executable certificate data via the field device to the terminal, wherein the executable certificate data comprise executable instructions and the digital certificate, receiving the executable certificate data by the terminal, and after the executable certificate data have been received by the terminal, executing the executable certificate data by the terminal, as a consequence of which the digital certificate is installed on the terminal. A field device executing the aforementioned method, and a computer-implemented method executed on this field device are also disclosed.

### FIELD OF THE INVENTION

The invention relates to a method for putting a digital certificate of a field device into service on a terminal. Another aspect of the invention proposes a field device that can be used while implementing this method. Further proposed is a computer-implemented method for execution on this field device.

### BACKGROUND OF THE INVENTION

Process automation technology makes wide use of field devices that serve to acquire and/or influence process variables. Examples of such field devices include fill level gauges, point level gauges and pressure gauges with sensors that acquire the corresponding process variables level, point level or pressure. Typical application scenarios for such field devices comprise areas such as flood forecasting, inventory management, or even other decentralized distributed measuring tasks. Known field devices of the aforementioned kind make it possible to transmit measured values, so that a superordinate unit triggers a predetermined action based on the determined measured value. For example, an inlet can be closed or an outlet can be opened based on the measured value of a level gauge if a limit has been exceeded.

In order to enable remote operation, configuration or inspection, a field device can provide for accessibility via a network connection. For example, a webserver application can be implemented in the field device. The latter can provide a user interface that can be accessed, for example via the HTTP protocol. The abbreviation HTTP stands for Hypertext Transfer Protocol. In this way, a user can use a web browser to remotely make device settings or retrieve measured values, for example. The user can connect with the field device via a terminal, for example via a personal computer.

For safety reasons, an encrypted communication is preferred between the field device and the terminal. The use of a digital certificate is also often provided. The digital certificate can be used by the terminal to verify that a remote station with which it is communicating is in fact the field device. Known methods from public key cryptography can be used for this purpose. For example, a secure communication via the HTTPS protocol can be established. The abbreviation HTTPS stands for Hypertext Transfer Protocol Secure.

However, communication via the HTTPS protocol assumes that the terminal can check the digital certificate of the field device. For example, this is possible if the digital certificate was stored on the terminal beforehand, so that a corresponding comparison can be made before communicating with the field device. This requires that the digital certificate be professionally installed on the terminal. If a user wishes to access the field device using their terminal, they must first install the digital certificate. To this end, for example, they can download the digital certificate from the field device via an unsecured connection, and install the digital certificate on the terminal. The ensuing communication between the terminal and the field device can take place via the HTTPS protocol. However, installation of the digital certificate is comparatively complicated, and might only be possible if done by technical experts.

### SUMMARY OF THE INVENTION

The object of the invention is to provide a simplified method for putting a digital certificate of a field device into service on a terminal. Another object of the invention is to provide a field device that can be used in conjunction with this method. A further object of the invention is to provide a computer-implemented method to be performed on such a field device.

The objects are achieved by the method and apparatus according to the attached claims which describe various embodiments of the invention. Let it be noted that the features enumerated in the independent and dependent claims can be combined in any manner desired, provided this is technically sensible. This also applies beyond the boundaries of the claim categories, even when a claim does not refer back to another claim. The description additionally characterizes and specifies the invention, in particular in conjunction with the figures. The features contained in the description can likewise be combined as desired, provided this is technically feasible.

A first aspect of the invention proposes a method for putting a digital certificate of a field device into service on a terminal, wherein the digital certificate is allocated to the field device, and provided to verify the identity of the field device during a communication with the field device via a secure data transmission protocol. The method involves sending an inquiry for transmitting the digital certificate to the field device by way of the terminal, and receiving the inquiry for transmitting the digital certificate by way of the terminal. In response to receiving the inquiry for transmitting the digital certificate, executable certificate data are sent by the field device to the terminal, wherein the executable certificate data comprise executable instructions and the digital certificate. The executable certificate data are further received by the terminal. The executable certificate data are executed by the terminal, so that the digital certificate is installed on the terminal. As a consequence, the digital certificate is put into service on the terminal.

The digital certificate is installed on the terminal by executing the executable certificate data. This makes it easier to install the digital certificate for a user of the terminal. Within the framework of the method according to the invention, the terminal initially makes the inquiry for transmitting the digital certificate. For example, this can involve a request for downloading the digital certificate. According to the invention, the download can take place via a website provided by the field device. According to the invention, it is possible to operate a webserver application on the field device that permits a configuration of the field device. The webserver application can be suitable according to the invention for providing data via the HTTP protocol and via the HTTPS protocol. More generally speaking, the webserver application can be suitable for providing data via an unsecured data transmission protocol and via a secure data transmission protocol.

According to the invention, it is possible that the terminal make the inquiry for transmitting the digital certificate other than via the HTTP protocol. For example, the inquiry can conceivably be transmitted via the FTP protocol, so that the inquiry can be an FTP inquiry. This is followed by the field device sending executable certificate data to the terminal. For example, this can be realized by way of a downloading process via the FTP protocol, in which an FTP application of the field device preferably sends the executable certificate data to the terminal.

The executable certificate data are executed on the terminal. By executing the executable certificate data, the digital certificate is installed on the terminal. An installation process performed within this framework can have very different characteristics, depending on an operating system of the terminal. For example, it is possible according to the invention that the certificate be copied to a specific folder of the terminal, specific registry settings be made on the terminal, specific program and/or system settings be made on the terminal, and/or some other steps be performed as required for activating or installing the digital certificate on the terminal.

In some embodiments, the installation process may necessitate an interaction with the user of the terminal. For example, it may be necessary for the user of the terminal to confirm the installation process or a portion of the installation process via an entry on the terminal. It can further be necessary for the user to enter specific data that are required for installing the digital certificate. Even if the described interaction with the user should be necessary, installing the digital certificate by means of the executable certificate data is to be preferred to manually installing the digital certificate, since the installation process is considerably simplified even in this case. After installation is complete, the certificate can preferably be used right away, so that it can be used directly on the terminal by a web browser application, for example. However, conceivable variants of the invention may require that the user have to subsequently make one or more adjustments to the terminal to ultimately make the digital certificate usable by the terminal. For example, the terminal can be a personal computer, a notebook, a tablet PC, a smartphone or some other computer.

During implementation of the method, it is preferred that at least one piece of information relating to an operating system of the terminal be sent from the terminal to the field device, and that the at least one piece of information relating to the operating system of the terminal be received by the field device, wherein the executable certificate data that the field device sends to the terminal are tailored for the operating system of the terminal. Depending on the operating system on the terminal, various steps may be required for installing the digital certificate on the terminal. In particular, executable instructions that can be executed on a first operating system cannot necessarily also be executed on a second operating system. Executable certificate data tailored for the operating system of the terminal are advantageously to be regarded as executable certificate data that can be executed on the terminal, wherein the execution causes the digital certificate to be installed on the terminal.

In addition, there can be differences between various operating system versions, thereby necessitating varying characteristics of the executable certificate data as a function of the used operating system version. For example, the information about the operating system can be transmitted to the field device by making a choice as to the user interface of the field device. For example, the operating system and/or an operating system version of the terminal could be selected by way of a dropdown list, which is displayed in a user interface provided by the field device. According to the invention, it is further possible that the field device extract at least one piece of information about the operating system from the data field that a web browser of the terminal transmits during communication with a webserver of the field device. For example, a so-called user-agent field can be evaluated, in which information about the used web browser as well as about the used operating system are transmitted by the terminal to the field device according to the HTTP protocol.

In particular, the at least one piece of information can involve an operating system type (e.g., Windows, MacOS or GNU/Linux). The at least one piece of information optionally contains a subtype of the operating system, a version number of the operating system or some other datum that characterizes the operating system. Depending on the at least one piece of information, the field device sends executable certificate data to the terminal, which are suitable for the terminal or its operating system. As a consequence, the method can be implemented with different operating system types or versions.

In response to receiving the at least one piece of information relating to the operating system of the terminal, it is advantageous for the field device to select the executable certificate data from a data memory of the field device as a function of the at least one piece of information to be sent to the terminal. For example, the field device can keep available several variants of the executable certificate data. Depending on an operating system type and/or an operating system version, for example, a suitable variant of the executable certificate data, i.e., one that matches the terminal, is loaded from the data memory and sent to the terminal.

The invention can provide that the field device receive the executable certificate data from a remote station, and store the latter. The field device can store the executable certificate data that it received, for example in an internal data memory of the field device. The executable certificate data are then available at a later point in time. The field device preferably receives several variants of the executable certificate data, and stores the latter. In principle, the remote station can be any device that can use a network interface of the field device to communicate with it. The remote station is preferably an update server, for example one provided by a manufacturer of the field device. However, it can be any other server, computer or the like. The executable certificate data are preferably encrypted by the remote station and transmitted to the field device, and the field device especially preferably authenticates the remote station in advance, so as to ensure an adequate security level.

In response to receiving the at least one piece of information relating to the operating system of the terminal, the field device generates the executable certificate data in such a way as to make them suitable for installing the digital certificate on the operating system of the terminal. According to this variant of the invention, the field device does not access stored, executable certificate data, but rather generates the latter when necessary. In particular, generation can be understood to mean that the digital certificate is suitably combined with the executable instructions. According to variants of the invention, the executable instructions can be generated or adjusted in such a way as to be suitable for installing the digital certificate on the operating system of the terminal. This can prove useful in particular given a plurality of different characteristics of operating system variants, so that not all required variants of the executable certificate data can be kept available in a data memory of the field device. In this case, the field device can generate the executable certificate data as a function of the operating system of the terminal. It is possible according to the invention for the field device to store the generated executable certificate data for subsequent further use. A generation of executable certificate data is also present when an existing program pattern for the executable certificate data is merely adjusted, for example by changing a stored installation path or adjusting a version number, an identifier or the like.

While implementing the method, it is preferable that the field device receive the digital certificate from a remote station, the executable certificate data be generated by the field device, and the executable certificate data be stored by the field device. According to this embodiment, the field device only receives the digital certificate from the remote station. This makes it necessary for the field device to generate the executable certificate data. According to the invention, this can take place by combining the digital certificate with executable instructions.

According to another advantageous embodiment of the invention, the executable certificate data are contained in an executable file. As a consequence, a single executable file can be provided for the user, which the latter need only execute. In this case, the user does not have to work with several files or even download several files separately, for example from the field device. Alternatively, it can be provided that the executable instructions and the digital certificate not be stored in an executable file, but rather in a file of some other type. According to the invention, it is possible for the data to be stored in a container file, in particular in a compressed container file, for example a ZIP archive that forms the executable certificate data.

According to one possible variant of the invention, the file is an executable binary file. For example, an executable .EXE or .MSI file can be provided for the Windows operating system. Other examples for executable binary files are files in the ELF format in the GNU/Linux operating system or the Mach-O format in the macOS operating system. The binary file can contain both executable instructions as well as the digital certificate.

The file can alternatively involve a script file. A script file is characterized in that it is executed by an interpreter. For example, these include PowerShell scripts in Windows or Shell scripts in Linux and macOS. As a rule, a script file can be retrieved just as easily as a binary file, so that there most often are no disadvantages as relates to user friendliness. However, the advantage to script files is that they can be generated or modified comparatively easily, since as a rule no binary code must be generated or modified. As a consequence, they are especially well suited for generation via the field device. The script file can contain both the executable instructions (preferably executable script lines) along with the digital certificate (preferably embedded in the form of text data which the executable instructions can access).

While executing the executable certificate data, the terminal preferably performs at least the following steps: If the terminal is not in an administrator mode, generate a user inquiry for switching the terminal into the administrator mode, and if a user entry is made on the terminal in response to the user inquiry and releases the switch into the administrator mode: Switch the terminal into the administrator mode and copy the digital certificate into a certificate memory of the terminal. If the terminal is already in the administrator mode, it is only necessary that the digital certificate be copied into the certificate memory of the terminal.

To enable installation of the digital certificate, it is often necessary that the operating system be in an administrator mode. Farther-reaching rights are present in the administrator mode. In particular, rights necessary for modifying system and/or operating system settings can here be involved. It is often not possible to install the digital certificate without administrator rights. The described procedure is preferably used to first generate a user inquiry for switching into the administrator mode if the operating system is not in the administrator mode. In this case, for example, the terminal user is prompted to switch into the administrator mode, so that the executable certificate data can be executed. For example, the user can here be prompted to enter an administrator password.

After the switch into the administrator mode, the digital certificate is installed. This preferably takes place by copying the digital certificate into a certificate memory of the operating system. For example, this can involve a file path in which digital certificates of the operating system can be stored. Applications on the terminal, for example web browser, access this file path, so as to read out digital certificates installed on the operating system. If the operating system is already in the administrator mode, no user inquiry for switching into the administrator mode is necessary, and the digital certificate can preferably be copied directly into the certificate memory. Within the framework of the method according to the invention, the executable certificate data can also contain additional instructions, for example for outputting information to a terminal user or requesting information from the user that is necessary for installing the digital certificate on the terminal.

It is preferred that the following steps be performed after installing the digital certificate on the terminal: Terminal sends an inquiry to the field device for establishing a connection via the secure data transmission protocol, field device receives the inquiry for establishing a connection via the secure data transmission protocol, field device transmits authentication data to the terminal, terminal verifies the authentication data based on the digital certificate and, if verification is successful, terminal and field device communicate via the secure data transmission protocol. After installation of the digital certificate on the terminal, communication can take place between the terminal and field device via the secure data transmission protocol.

In order to initiate the communication process, the terminal submits an inquiry to the field device for establishing a correspondingly secured connection. The field device now transmits the authentication data to the terminal. For example, the authentication data can involve the digital certificate, but also involve other data which allow authentication of the field device based on the digital certificate stored in the terminal. For example, authentication can also take place based on cryptographic keys and/or based on cryptographic signatures.

According to an advantageous embodiment of the invention, the secure transmission protocol is the HTTPS protocol. The HTTPS protocol is an internet communication protocol with which data can be transmitted encrypted, and which also permits an authentication of communication participants. However, the secure transmission protocol can also be some other protocol for transmitting data that allows encryption as well as authentication. The digital certificate is preferably a digital certificate according to the X.509 standard. The X.509 standard is an ITU-T standard for generating digital certificates. However, it is also possible according to the invention to use a different digital certificate.

Another aspect of the invention proposes a field device with a sensor for acquiring a measured value, with a network interface and with a data processing apparatus, wherein the data processing apparatus is configured to provide an option for operating the field device by means of the network interface via a secure data transmission protocol, and wherein the data processing apparatus is further configured to receive an inquiry for transmitting a digital certificate from a terminal by means of the network interface, wherein the digital certificate is allocated to the field device and provided for verifying an identity of the field device during a communication with the field device via the secure data transmission protocol. The data processing apparatus is further configured to, in response to receiving the inquiry for transmitting the digital certificate, initiate the sending of executable certificate data to the terminal by means of the network interface, wherein the executable certificate data comprise executable instructions and the digital certificate.

As a consequence, the field device according to the invention can be used in conjunction with the method described above. The field device can have all features that were already described above in relation to the field device. According to the invention, the field device can be suitable for measuring a level, a point level, a pressure or some other measured value. For example, the network interface can be an ethernet interface or a WLAN interface. However, some other network interface can also be involved, for example a two-wire interface. The option for operating the field device by means of the network interface is preferably implemented by a webserver application installed on the field device. The latter preferably provides for an option to configure the field device and/or retrieve field device data. According to the invention, a user interface of the field device can be provided for this purpose, which is accessible via a web browser. According to the invention, the data processing apparatus can be a microcontroller, an embedded computer or some other computer or some other computing unit of the field device. The data processing apparatus is preferably connected with the sensor and/or with the network interface of the field device. According to the invention, it is further possible for the field device to have a data memory, which preferably is likewise connected with the data processing apparatus.

According to an advantageous embodiment of the invention, the field device can receive at least one piece of information relating to the operating system of the terminal via the network interface of the field device. In advantageous embodiments, the data processing apparatus can be configured to prompt the field device to send executable certificate data tailored for the operating system of the terminal to the terminal via the network interface.

According to advantageous embodiments, the field device is configured to, in response to receiving the at least one piece of information relating to the operating system of the terminal, select the executable certificate data to be sent to the terminal from a data memory of the field device as a function of the at least one piece of information for dispatch to the terminal. According to the invention, this can be done by the data processing apparatus.

The field device can further be configured to receive the executable certificate data from a remote station via the network interface. In particular, the data processing apparatus can be configured to have the executable certificate data received from the remote station stored in a data memory of the field device. It is additionally advantageous that the field device be configured to, in response to receiving the at least one piece of information relating to the operating system of the terminal, generate the executable certificate data in such a way as to make them suitable for installing the certificate on the operating system of the terminal. The certificate data are advantageously generated by means of the data processing apparatus of the field device.

The field device can advantageously be configured to receive the digital certificate via the network interface, generate executable certificate data, in particular by means of the data processing apparatus of the field device, and store the executable certificate data in the data memory of the field device. It goes without saying that the executable certificate data can according to the invention be contained in an executable file, wherein the file can be an executable binary file or a script file according to embodiments of the invention.

The field device can further be configured to receive an inquiry for establishing a connection via the secure data transmission protocol. This preferably takes place via the network interface of the field device. The field device can be configured to send authentication data to the terminal in response to receiving the inquiry. A communication can thereafter take place between the terminal and the field device via the secure data transmission protocol if a verification of authentication data by the terminal was successful. According to the invention, the secure data transmission protocol can be the HTTPS protocol. According to the invention, the digital certificate can be an X.509 certificate.

Another aspect of the invention proposes a computer-implemented method for execution on a field device with a network interface. The computer-implemented method comprises at least the following steps: Receiving an inquiry for transmitting a digital certificate from a terminal by means of the network interface, wherein the digital certificate is allocated to the field device, and provided for verifying an identity of the field device during a communication with the field device via a secure data transmission protocol and, in response to receiving the inquiry for transmitting the digital certificate, triggering a sending of executable certificate data to the terminal by means of the network interface, wherein the executable certificate data comprise executable instructions and the digital certificate. The method is preferably implemented by the data processing apparatus of the field device described above. According to the invention, the computer-implemented method can be implemented in any modifications, so as to realize functions of the field device described above.

The invention will be exemplarily described based on the drawings. Shown here on:

### BRIEF DESCRIPTION OF THE DRAWINGS

FIG. 1 is a schematic illustration of a field device and a terminal,

FIG. 2 is a sequential diagram for putting a digital certificate of the field device into service on the terminal, and

FIG. 3 is a schematic illustration of executable certificate data.

### DETAILED DESCRIPTION OF THE DRAWINGS

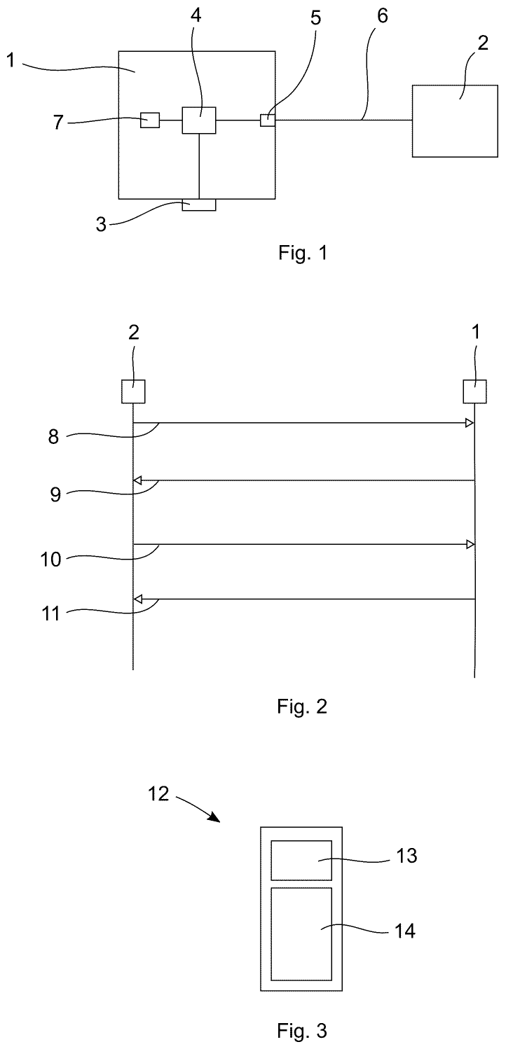

FIG. 1 shows a schematic illustration of a field device 1 and a terminal 2. The field device 1 has a sensor 3 for measuring a pressure. The sensor 3 is connected with a data processing apparatus 4, which can store and evaluate measured values acquired by the sensor 3. The data processing apparatus 4 is a powerful microcontroller, on which a webserver application is operated. The data processing apparatus 4 is further connected with a network interface 5 of the field device 1. The webserver application provides a user interface of the field device 1. A terminal 2 can access the user interface via a network connection 6 so as to introduce settings on the field device 1. The field device 1 is further equipped with a data memory 7, which is connected with the data processing apparatus 4 of the field device 1.

FIG. 2 shows a sequential diagram for putting a digital certificate of the field device 1 into service on the terminal 2. In a first step, the terminal 2 sends a certificate inquiry 8 for transmitting the digital certificate to the field device 1 via the network connection. The certificate inquiry 8 is triggered by a user of the terminal 2 pressing a field for downloading the certificate in the user interface, which the field device 1 provides via its network interface. In the user interface of the field device 1, the user choses their operating system beforehand, so that the certificate inquiry 8 also contains a piece of information relating to the operating system of the terminal 2.

After receiving the certificate inquiry 8 and information about the operating system of the terminal 2, the data processing apparatus of the field device 1 generates executable certificate data. The executable certificate data contain a digital certificate of the terminal 2 as well as executable instructions. The field device 1 generates the executable instructions in such a way that they are suitable for execution on the terminal 2. For this purpose, the information about the operating system of the terminal 2 is evaluated. In order to generate the executable certificate data, the digital certificate is loaded from the data memory of the field device 1 beforehand. The field device 1 now initiates an instruction dispatch 9, wherein the executable certificate data are sent to the terminal 2. The certificate inquiry 8 and instruction dispatch 9 take place via the HTTP protocol.

The terminal 2 receives the executable certificate data. A user now initiates the execution of executable certificate data on the terminal 2, as a result of which the digital certificates are installed on the terminal 2. In the process, the digital certificate is copied into a certificate memory of the terminal 2. An HTTPS connection can now be built up between the field device 1 and the terminal 2. For this purpose, the terminal 2 makes a connection inquiry 10 to the field device 1, which kicks off an initialization of the HTTPS protocol. After the connection inquiry 10 has been received, the field device 1 initiates a certificate dispatch 11 to the terminal 2, wherein the field device 1 transmits the digital certificate to the terminal 2. The field device 2 compares the digital certificate obtained in this way with the digital certificate stored in its certificate memory, so as to validate the digital certificate. The field device 1 is authenticated in this way. Steps not described here ensue to conclude the initialization of the HTTPS protocol. An encrypted communication can subsequently take place between the field device 1 and terminal 2 via the HTTPS protocol.

FIG. 3 shows a schematic depiction of executable certificate data 12. The executable certificate data 12 are formed by a script file, which contains the digital certificate 13. Aside from the digital certificate 13, the script file also contains executable instructions 14. When the executable certificate data 12 are retrieved on the terminal, the executable instructions 14 are executed. This copies the digital certificate 13 into the certificate memory of the terminal.

### REFERENCE LIST

1 Field device
2 Terminal
3 Sensor
4 Data processing apparatus
5 Network interface
6 Network connection
7 Date memory
8 Certificate inquiry
9 Instruction dispatch
10 Connection inquiry
11 Certificate dispatch
12 Executable certificate data
13 Digital certificate
14 Executable instructions

1. A method for putting a digital certificate of a field device into service on a terminal, wherein the digital certificate is allocated to the field device and provided to verify the identity of the field device during a communication with the field device via a secure data transmission protocol, wherein the method comprises:
Sending an inquiry for transmitting the digital certificate to the field device by way of the terminal,
Receiving the inquiry for transmitting the digital certificate by the field device,
In response to receiving the inquiry for transmitting the digital certificate, sending executable certificate data via the field device to the terminal, wherein the executable certificate data comprise executable instructions and the digital certificate,
Receiving the executable certificate data by the terminal, and
After the executable certificate data have been received by the terminal, executing the executable certificate data by the terminal, as a consequence of which the digital certificate is installed on the terminal.

2. The method according to claim 1, wherein
the method further comprises:
Sending at least one piece of information relating to an operating system of the terminal from the terminal to the field device, and
The field device receiving the at least one piece of information relating to the operating system of the terminal,
wherein the executable certificate data sent by the field device to the terminal are tailored for the operating system of the terminal.

3. The method according to claim 2, wherein
the field device, in response to receiving the at least one piece of information relating to the operating system of the terminal, selects the executable certificate data to be sent to the terminal from a data memory of the field device as a function of the at least one piece of information for dispatch to the terminal.

4. The method according to claim 1, wherein
the method further comprises:
The field device receiving the executable certificate data from a remote station,
The field device storing the executable certificate data.

5. The method according to claim 2, wherein
the field device, in response to receiving the at least one piece of information relating to the operating system of the terminal, generates the executable certificate data in such a way as to make them suitable for installing the certificate on the operating system of the terminal.

6. The method according to claim 5, wherein
the method further comprises:
The field device receiving the digital certificate from a remote station,
The field device generating the executable certificate data, and
The field device storing the executable certificate data.

7. The method according to claim 1, wherein
the executable certificate data are contained in an executable file.

8. The method according to claim 7, wherein
the file is an executable binary file.

9. The method according to claim 7, wherein
the file is a script file.

10. The method according to claim 1, wherein
the terminal performs at least the following steps during execution of the executable certificate data:
If the terminal is not in an administrator mode, generating a user inquiry for switching the terminal into the administrator mode and, if a user entry on the terminal is made in response to the user inquiry and releases the switch into the administrator mode:
switching the terminal into the administrator mode and
copying the digital certificate into a certificate memory of the terminal,
If the terminal is already in the administrator mode, copying the digital certificate into the certificate memory of the terminal.

11. The method according to claim 1, wherein
the method further comprises:
After the digital certificate has been installed on the terminal, the terminal sends an inquiry to the field device for establishing a connection via the secure data transmission protocol,
The field device receives the inquiry for establishing a connection via the secure data transmission protocol,
The field device transmits authentication data to the terminal,
The terminal verifies the authentication data based on the digital certificate and,
If verification is successful, the terminal and field device communicate via the secure data transmission protocol.

12. The method according to claim 1, wherein
the secure data transmission protocol is the HTTPS protocol.

13. The method according to claim 1, wherein
the digital certificate is an X.509 certificate.

14. A field device with a sensor for acquiring a measured value, with a network interface and with a data processing apparatus, wherein the data processing apparatus is configured to provide an option for operating the field device by means of the network interface via a secure data transmission protocol, and wherein the data processing apparatus is further configured to:
receive an inquiry for transmitting a digital certificate from a terminal by means of the network interface, wherein the digital certificate is allocated to the field device and provided for verifying an identity of the field device during a communication with the field device via the secure data transmission protocol, and,
in response to receiving the inquiry for transmitting the digital certificate, initiate the sending of executable certificate data to the terminal by means of the network interface, wherein the executable certificate data comprise executable instructions and the digital certificate.

15. A computer-implemented method for execution on a field device with a network interface, comprising:
Receiving an inquiry for transmitting a digital certificate from a terminal by means of the network interface, wherein the digital certificate is allocated to the field device and provided for verifying an identity of the field device during a communication with the field device via the secure data transmission protocol,
In response to receiving the inquiry for transmitting the digital certificate, initiating the sending of executable certificate data to the terminal by means of the network interface, wherein the executable certificate data comprise executable instructions and the digital certificate.
